(19) United States
(12) Patent Application Publication
(10) Pub. No.: US 2010/0083147 A1
(43) Pub. Date: Apr. 1, 2010

(54) PARAMETER-DRIVEN DATA AGGREGATOR

(75) Inventor: Robert J. Gaffney, Lakeway, TX (US)

Correspondence Address: VIRTUAL LAW PARTNERS LLP, P.O. BOX 1329, MOUNTAIN VIEW, CA, 94042, US

(73) Assignee: CALLIDUS SOFTWARE, INC., San Jose, CA (US)

(21) Appl. No.: 12/566,548

(22) Filed: Sep. 24, 2009

Related U.S. Application Data
(60) Provisional application No. 61/101,848, filed on Oct. 1, 2008.

(51) Int. Cl. G06F 3/00

(52) U.S. Cl. 715/762

(57) ABSTRACT

Exemplary embodiments are disclosed for a method and system of parameterizing data aggregation performed by a data integrator executing on a computer. Aspects of the exemplary embodiment include in response to receiving business rules input from an end-user through a graphical user interface, storing the business rules as aggregation parameters in a repository external to the data integrator; reading the aggregation parameters, the aggregation parameters specifying the source table of transaction data, a target table for storing aggregation results, and summarization requirements specifying aggregation actions to be performed on fields of at least one of the source table in the target table; and aggregating the transaction data based on the summarization requirements, including grouping and summing transaction values, whereby the aggregation parameters enable aggregation of the transaction data from the source table to the target table without modifying code comprising the data integrator.

### CROSS-REFERENCE TO RELATED APPLICATIONS

This application claims the benefit of provisional Patent Application Ser. No. 61/101,848, filed Oct. 1, 2008, assigned to the assignee of the present application, and incorporated herein by reference.

### BACKGROUND

Incentive-based compensation plans have been used by corporations as a tool to communicate corporate objectives to a sales force to focus sales activities and to compensate the sales force accordingly when they meet or exceed stated goals. The incentive compensation plan should to reward top performers while avoiding overpayment, and ensure that the company is in compliance with all relevant governance requirements.

In the past, companies have managed incentive compensation utilizing manual, spreadsheet-driven processes and homegrown solutions. Spreadsheets proved inadequate in their inability to accommodate multiproduct sales interrelationships (i.e. product bundles, cross-selling and up-selling incentives). In addition, such legacy approaches have proven to be inflexible and error-prone.

More recently, rule-based incentive management solutions have become available that are more flexible and accurate. For example, the assignee of the present application currently offers an incentive management application that measures the performance of a sales force using sales transaction data. Incentive management solutions enable real-time insight into sales commission status, giving management the ability to proactively incentive program performance and effectiveness in detail. In operation, sales transaction records are imported into an incentive management application from their source of record using a custom data integration process, credited to payees, and processed using a compensation calculation engine to measure sales performance and calculate incentive pay. In data warehousing, this process may be referred to as extract, transform, and load (ETL), where data from outside sources is extracted, transformed to fit operational needs, and then loaded into a target database or data warehouse.

Sales transaction records are usually very detailed and numerous. For example, a record may correspond to a single sale of a single product on a particular day by a particular customer in a particular locale. It is a common practice to preprocess these sales transactions prior to their use as an input to the compensation calculation engine. One common reason to preprocess transactions is to pre-assign credit of the transaction to payees (using some external data source that relates a payee or sales territory to attributes on a sales transaction record), prior to the data load of transactions into a compensation transaction engine.

It is also common to “roll up” or aggregate sales transaction measures to a higher “grain” to reduce data volumes and thus process the sales transaction data more quickly. For example, when processing sales transactions, the requirement is to accept a large volume of overall sales transaction data, credit the sales transactions to salespeople or territories, and then to reduce or summarize the volume of the sales transaction data, so that the software needs only to process thousands of records instead of billions of records, for instance.

In data warehousing, such records would be referred to as aggregate facts that include numeric measures and shared attributes. When aggregating fact data, determining the correct “grain” (the level at which to sum the fact measures) is driven by business requirements. In the context of incentive compensation, a highest possible grain could be to roll up the sales transaction data to one transaction per financial period per payee, while the lowest possible grain would be to maintain the detailed level of the original transactions. The ideal grain is usually somewhere in between: the data should be summarized sufficiently to enable rapid processing, but detailed enough to allow meaningful reporting and analysis of the data.

Sales transaction preprocessing is always a customized process, as the sales data, crediting methods, and aggregation requirements vary from business to business. With conventional incentive management applications, the traditional approach has been to program a customer's business requirements into custom data integration code, including the grain to which transactions are aggregated (assuming they are aggregated). The custom data integration code receives all the transaction data, rolls up the transaction data by summing all the measures on the sales transaction records to a specified grain (resulting in a smaller number of aggregated records), and then loads the set of aggregated records into the incentive management application as part of data integration.

The level at which the data is aggregated is driven by the customer's business requirements or needs, which can easily change. In the traditional approach, if the customer wants to aggregate sales transaction data to a product family level instead of a product sub-family level, for example, a programmer would have to go back and change the data integration code, retest the code, and so on. Such a manual process is unduly time consuming and costly. Accordingly, it would be desirable to provide an improved data aggregation process.

### BRIEF SUMMARY

Exemplary embodiments are disclosed for parameterizing data aggregation performed by a data integrator executing on a computer. Aspects of the exemplary embodiment include in response to receiving business rules input from an end-user through a graphical user interface, storing the business rules as aggregation parameters in a repository external to the data integrator; reading the aggregation parameters, the aggregation parameters specifying the source table of transaction data, a target table for storing aggregation results, and summarization requirements specifying aggregation actions to be performed on fields of at least one of the source table in the target table; and aggregating the transaction data based on the summarization requirements, including grouping and summing transaction values, whereby the aggregation parameters enable aggregation of the transaction data from the source table to the target table without modifying code comprising the data integrator.

According to the exemplary embodiment, a customizable, flexible and reusable method for aggregating fact data is provided that is configurable by a user without changing the underlying code. Business rules entered by an end-user are parameterized, stored in a parameter table, and used to perform data aggregation. Specifics of a source table containing source data and a target table no longer need to be hardcoded, dispensing with the need to modify and retest the code every time the business rules change.

### BRIEF DESCRIPTION OF SEVERAL VIEWS OF THE DRAWINGS

FIG. 1 is a block diagram illustrating an exemplary system environment in which one embodiment of the parameter-driven data aggregator may be implemented.

FIG. 2 is a flow diagram illustrating one environment of a process for parameter driven data aggregation performed by the data aggregator.

FIG. 3 is a block diagram illustrating the fields comprising customizable aggregation parameter records in the aggregation parameter table.

FIG. 4 is a block diagram illustrating contents of an example aggregation actions table.

FIG. 5A is a diagram illustrating an example source table.

FIG. 5B is a diagram illustrating an example resulting target table that has been created prior to run-time processing.

FIG. 5C is a diagram illustrating an example aggregation parameter table that includes the columns described with respect to FIG. 3 and which is populated from the user-entered business rules.

FIG. 6 is a flow diagram illustrating the aggregation/alignment process according to one embodiment.

### DETAILED DESCRIPTION

The exemplary embodiment relates to a parameter-driven data aggregation. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

A data integration process is disclosed that can be used to aggregate facts during a step in an ETL process, such as compensation calculation by an incentive management application. According to exemplary embodiments, the data aggregator is designed to perform parameter-driven aggregation, placing variables of fact aggregation in the control of an end-user of the data. These parameters may describe a source table, a target table, and summarization requirements so that data can be aggregated from any database table or view to another database table without embedding the specifics of either in data integration code. Although the preferred embodiment will be described as implemented in an incentive management context for use with sales transaction data, the data aggregator can be used in any ETL process to provide a reusable aggregation component that allows a higher degree of control by the end-user, dispensing with the need for code modification in response to business requirement changes.

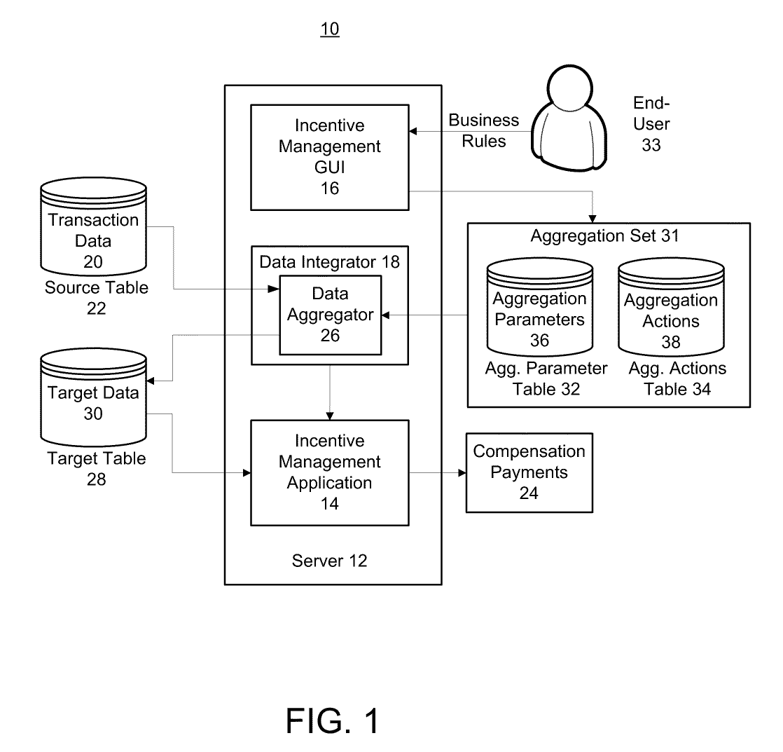

FIG. 1 is a block diagram illustrating an exemplary system environment in which one embodiment of the parameter-driven data aggregator may be implemented. In this embodiment, the system 10 may include a server 12 that executes an incentive management application 14 and a data integrator 18. The incentive management application 14 uses transaction data 20 stored in one or more source tables 22 to measure performance of a sales force and calculate compensation payments 24 (e.g., commissions) owed to the sales force using a compensation calculation engine (not shown). The incentive management application 14 may include an incentive management graphical user interface (GUI) 16 and the data integrator 18 may include a data aggregator 26.

The data integrator 18 may include an extract, transform, and load (ETL) process, where data from outside sources is extracted, transformed to fit operational needs, and then loaded into a target database. In this embodiment, the data integrator 18 imports high volumes of transaction data 20 in the form of sales transaction records from the source table 22, and aligns the sales transaction records to customer sales territories. The data integrator 18 may also preprocess the sales transactions prior to the input of the sales transactions to the incentive management application 14. One common reason to preprocess sales transaction is to pre-assign credit of the sales transaction to payees (using an external data source that relates a payee or sales territory to attributes on a sales transaction record).

The data integrator 18 further includes a data aggregator 26 that is designed to be reusable with any ETL process for reducing data volumes during data integration. In the example preferred embodiment, the data aggregator 26 is used to aggregate or roll up the transaction data 20 to a higher grain to reduce data volumes and thus enable the incentive management application 14 to process the transaction data 20 more quickly. The data aggregator 26 aggregates the transaction data 20 by grouping and summing of transaction values, thus reducing the data volumes that must be processed by the incentive management application 14 and increasing the speed of the process. The aggregated transaction data may be stored in a target table 28 as target data 30, as explained further below.

Although the data aggregator 26 is described as aggregating transactions data, the data aggregator 26 may be used to aggregate any type of facts that have numeric values and attributes, where the attributes map to business perspectives or dimensions. As used herein, dimension may be any element in a data model that can be displayed orthogonally with respect to other combinations of elements in the data model. For example, a report showing sales by customer, product and geography, would be taken from three dimensions of a data model.

In conventional systems, sales transaction preprocessing is a customized process, as the sales data, crediting methods, and aggregation requirements vary from business to business. The conventional process is to program business requirements into custom data integration code, including the grain to which transactions are aggregated (if they are aggregated). The traditional approach requires that the data integration code be modified and retested every time a customer's business requirements change.

According to the exemplary embodiment, the data aggregator 26 is parameter-driven and performs data aggregation based on parameters input from a repository called an aggregation set 31. The aggregation set 31 may include an aggregation parameter table 32 and an aggregation actions table 34, the contents of which are provided at least in part by an end-user 33. The aggregation parameters 36 may be stored as classifiers of a particular type. The aggregation parameters 36 may specify how sets of rows in the source table 22 are rolled up to one row, and what to do with the columns/fields of the source table 22. The source and target tables 22 and 28 may take any form, as long as the structure of the source table 22 has most, if not all, of the columns that the target table 28 has, and as long as the source table 22 is different than the target table 28 (i.e., the data aggregator 26 does not aggregate data from the source in place, but instead reads the source data from one table and writes aggregated data to another table).

Enabling the end-user 33 to input business rules gives control over data integration processing to the end-user 33, such as an employee or contractor of a business that is a customer of the incentive management application 14. The end-user 33 inputs business rules that control aggregation through the incentive management GUI 16. The business rules are then stored as part of the aggregation set 31. The aggregation set 31 controls the grain or level at which the transaction data 20 is aggregated into the target data 30. The aggregation parameters 36 in the aggregation parameter table 32 may describe how the source table 22 maps to the target table 28 (e.g., transaction data field A maps to target data field B), while a set of aggregation actions 38 stored in the aggregation actions table 34 controls a transformation of fields in the source table 22 to fields of the target table 28.

In one embodiment, the data integrator 18 or the data aggregator 26 may read the aggregation parameters 36 and the aggregation actions 38 and generate dynamic SQL to execute the transformation of the transaction data 20 to target data 30. In another embodiment, the data aggregator 26 may generate the dynamic SQL. Once the dynamic SQL is executed and the target table 28 populated with aggregated target data 30, the target data 30 is used for incentive compensation processing by the incentive management application 14.

In one embodiment, the incentive management application 14, the data integrator 18, the data aggregator 26, and the incentive management GUI 16 are implemented as software components. In another embodiment, the components could be implemented as a combination of hardware and software. Although the incentive management application 14, the data integrator 18, and the incentive management GUI 16 are shown as separate components, the functionality of each may be combined into a lesser or greater number of modules/components. In addition, although a server 12 is shown hosting the incentive management application 14 and the data integrator 18, the incentive management application 14 and the data integrator 18 may be run on any type of one more computers that have memory and processor.

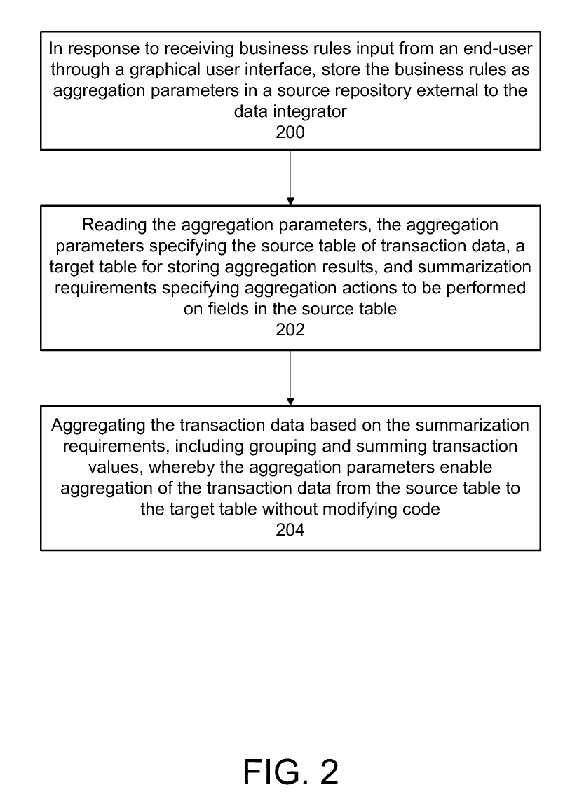

FIG. 2 is a flow diagram illustrating a parameter driven data aggregation process performed by the data aggregator 26. In response to receiving the business rules input from an end-user 33 through the graphical user interface 16, the business rules are stored as aggregation parameters 36 in a repository external to the data integrator 18 (block 200).

In one embodiment, the data integrator 18 receives the business rules from the incentive management GUI 16, converts the business rules into the aggregation parameters 36, and stores the aggregation parameters 36 as records in the aggregation parameter table 32. In another embodiment, the incentive management application 14 or a combination of the data integrator 18 and the incentive management application 14 may control the storing of the business rules as the aggregation parameters 36 in the aggregation parameter table 32.

The aggregation parameters 36 stored in the aggregation set 31 are then read, by the data aggregator 26 in one embodiment, where the aggregation parameters specify a source table 22 of the transaction data 20, a target table 28 for storing aggregation results, and summarization requirements specifying aggregation actions to be performed on fields of at least one of the source table 22 in the target table 28 (block 202).

In one embodiment, the summarization requirements comprise the aggregation actions 38. In one embodiment, at least a portion of the aggregation parameter records in the aggregation parameters table 32 specify a source field from the source table 22, a target field in the target table 28 to which the source field maps, and an aggregation action 38 to be performed on the source field. Example aggregation actions 38 that could be performed on a source field containing a numeric value may include mathematical and logical operations such as summation, averaging, counting, and the like. Example aggregation actions 38 that could be performed on a source field containing a text value may include string and character operations such as group by, min, max, skipped, and the like.

The transaction data 20 from the source table 22 is then aggregated based on the summarization requirements, including grouping and summing transaction values, whereby the aggregation parameters 36 enable aggregation of the transaction data 20 from the source table 22 to the target table 20 without modifying code comprising the data integrator 18 or the data aggregator 26 (block 204).

In response to reading each of the plurality of aggregation records from the aggregation parameter table 32 that map the source fields to the target fields, one or more dynamic SQL statements is generated, which when executed, performs the specified aggregation actions 38 on the corresponding source fields, transforming the transaction data 20 into the aggregated target data 30.

Execution of the dynamic SQL results in the plurality of transaction data 20 records being aggregated into a lesser number of one or more target data 30 records. For example, assume that a sale transaction record has a customer ID, a sales amount, a state, and a zip code. Assume that in the source table 22, there are many records for the same customer ID, state and zip code. One option would be to summarize those records to generate one record per customer ID, state and zip code, with a sum of the value, for example, by grouping the records by customer ID plus state and zip code. If the end-user 33 wants to see the data at a higher level and drop the zip code, the end-user 33 may change the aggregation parameters so that the grouping is based only on customer ID and state.

According to the exemplary embodiments, one benefit of parameterizing the business rules is that it dispenses with the need to hardcode the specifics of the source table 20, the target table 30 and the aggregation actions 38 in the data integrator 18 and/or the data aggregator 26, which means there is no longer a need to modify the code when the business rules are changed. Thus, the exemplary embodiments provide a customizable, flexible and reusable method for aggregating fact data, configurable by a user without changing the underlying code.

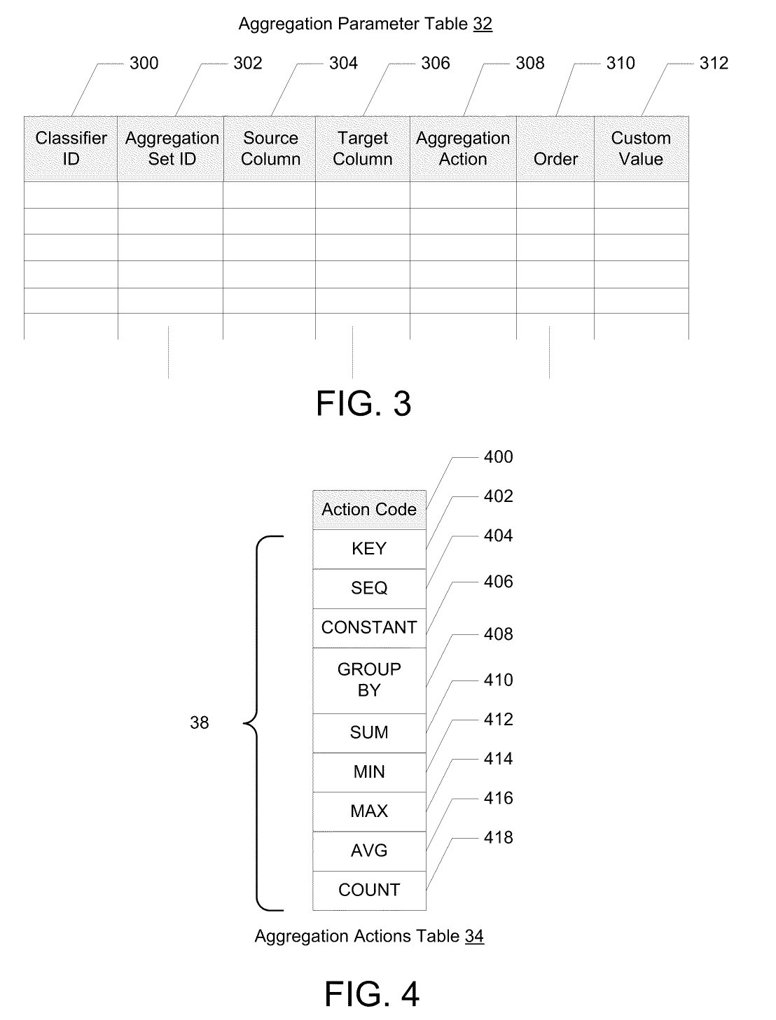

FIG. 3 is a block diagram illustrating the fields comprising customizable aggregation parameter records in the aggregation parameter table 32. According to the exemplary embodiment, each aggregation parameter record in the aggregation parameter table 32 may include the following fields: a classifier ID 300, an aggregation set ID 302, a source column 304, a target column 306, an aggregation action 308, an order 310, and a constant value 312.

In one embodiment, the aggregation parameters 36 are stored in the aggregation set 31 as classifiers. The classifier ID 300 is a unique key for each row in aggregation parameter table 32. In one embodiment, there may be several different aggregation actions running within the same process, and it must be known which aggregation parameters 36 to execute for any given target. The aggregation set ID 302 is used to name and identify each aggregation set 31 collectively. All the records for one aggregation set 31 are read for one execution by the data aggregator 26.

The source column 304 contains a name or ID of a column or field from the source table 22. The target column 306 contains a name or ID of a column or field from the target table 28. Values entered into an aggregation parameter record for the source column 304 and the target column 306 maps the source column to the target column. The aggregation action 308 contains a name or ID of an aggregation action that is to be performed on the data for the combination of the specified source field and target field. A set of available aggregation actions 38 are stored in the aggregation actions table 34. The order 310 field contains a value specifying the ordering of the columns in the target table 30, and the customer value 312 contains a constant value that may be used by particular aggregation actions 38.

FIG. 4 is a block diagram illustrating contents of an example aggregation actions table 34. In one embodiment, the aggregation actions table 34 includes one column containing a set of available aggregation actions 38 that are identified by an action code 400. In this embodiment, the available aggregation actions 38 may include Key 402, Seq 404, Constant 406, Group By 408, Sum 410, Min 412, Max 414, Avg 416, and Count 418. As described above, most of the aggregation actions 38 operate on the source column 304. However, some of the aggregation actions 38, such as Key 402, Seq 404, and Constant 406, do not operate on the source column 304 and instead perform operations on the target column 306.

The aggregation action Key 402 is derived at runtime and is used by the system to make the target column 306 a key. The aggregation action Seq 404 writes a sequential number from 1 to N to the target column 306 of sequential records. The aggregation action Constant 406 works a connection with the constant value 312 field to always write a value specified in the custom value 312 field into the target column 306.

The following aggregation parameters 36 transform values specified in the source column 304 into values suitable for the target column 306. The aggregation action Group By 408 summarizes records from the source table 22 according to the value specified in the source column 304. Aggregation actions such as Sum 410, Min 412, Max 414, Avg 416, and Count 418 are mathematical operators that are performed on the source column 304 from a group of records in the source table 22, rather than on the source/target column pair.

The process of parameterizing data aggregation will be further explained by way of example. In this example, assume that a business named Acme needs to roll up detailed transactions at a product ID level to a product group level prior to loading those transactions into the incentive management application 14.

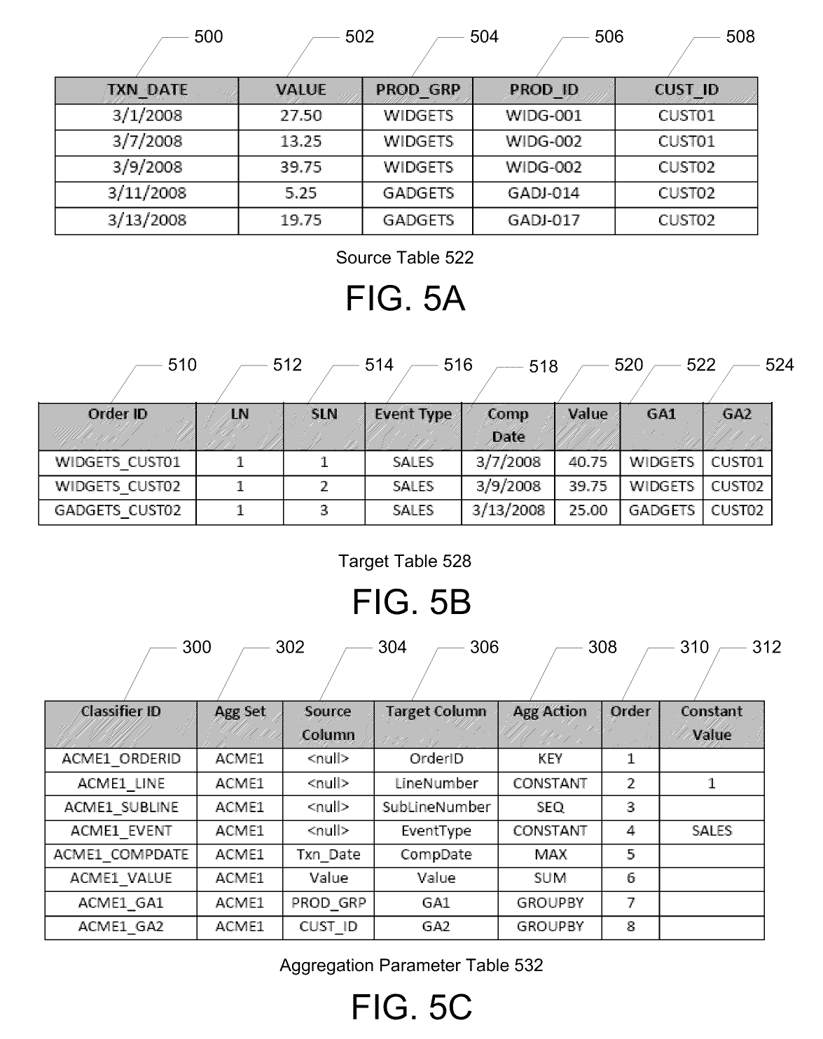

FIGS. 5A-5C are diagrams illustrating example Acme tables. FIG. 5A is a diagram illustrating an example source table 522. In this example, assume a simple source table named ACME_TXN includes source transaction data in the following columns: TXN_DATE 500 (transaction date), VALUE 502, PROD_GRP 504 (product group), PROD_ID 506 (product ID), and CUST_ID 508 (Customer ID). The source transactions are to be rolled up to Product Group+Customer ID.

FIG. 5B is a diagram illustrating an example resulting target table 28 that has been created, but not populated, prior to run-time processing. Assume the Target table is named OD_TRANS_AGG and has the columns Order ID 510, Line Number (LN) 512, Sub Line Number (SLN) 514, Event Type 516, Comp Date 518, Value 520, GA1 522, and GA2 524.

FIG. 5C is a diagram illustrating an example aggregation parameter table 532 that includes the columns described above with respect to FIG. 3 and which is populated from the user-entered business rules.

In one embodiment, the end-user 33 may enter run time parameters into the data integrator 18 specifying the aggregation set ID (a pointer to the classifier set), the source table 522, and the target table 528, where the aggregator set ID is ACME1:

agg_set_id=ACME1
source_table_name=ACME_TXN
target_table_name=OD_TRANS_AGG

In this particular example, the aggregation parameter table 532 has eight rows and is all the rows for the particular aggregation set have and Agg. Set ID 302 of Acme1. The example is basically populating the eight columns of the target table 528 based on the aggregation actions 308 in the aggregation parameters table 532 that specify what is to be done for each target column 306.

In the first row of the aggregation parameter table 532, the specified the target column 306 is “OrderID” and the associated aggregation action 308 is Key 402. The key is derived at runtime and use by the system to make the target column a key and thus the source column is null. In the second row of the aggregation parameter table 532, the specified the target column 306 is “LineNumber” (LN) and has an aggregation action 308 of Constant 406, and therefore is not relevant to a source column. Instead, the aggregation action 308 of Constant 406 will write the value of “1” from the constant value 312 field to the target column “LineNumber”. In the third row of the aggregation parameter table 532, the specified target column 306 is “SubLineNumber” and has and aggregation action 308 of SEQ, which writes a sequential number from 1-n to the target column “SubLineNumber” and is also not relevant to the source column. In the fourth row of the aggregation parameter table 532, the specified target column 306 is “EventType” and also has an aggregation action of Constant 406, which writes the value of “Sales” from the constant value 312 field to the target column “EventType”.

The next four rows of the aggregation parameter table 532 read from the source column 304 and write to the target column 306. One row specifies transaction date, i.e., “TXN_Date”, as the source column 304, specifies “CompDate” as the target column 306, and specifies Max 414 as the aggregation action 308, which will take the maximum value of the transaction date from a group of records and write the value into the “CompDate” field of the target table 528. For example, if there are three records for the groups being summarized into one record, the action Max 414 will select the maximum of the three transaction dates and write that value into the “CompDate.”

The next row specifies “Value” as the source column 304, specifies “Value” as the target column 306, and specifies Sum 410 as the aggregation action 308, which will sum the values in the Value field of a group of source records and write the result to the “Value” field of the target table 528. Typically, the aggregation action Sum 410 is performed on a dollar amount.

The last two records in the aggregation parameter table 532 are examples of parameters controlling grouping or grain, which is the level to which the data aggregator 26 summarizes. In this example, the records are being summarized at a product group and customer ID level. One row specifies “PROD_GRP” as the source column 304, specifies “GA1” as the target column 306, and specifies “Group By” 408 as the aggregation action 308. The other row specifies “CUST_ID” as the source column 304, specifies “GA2” as the target column 306, and specifies “Group By” 408 as the aggregation action 308. In both cases, the aggregation action is Group By 408, which will group the two fields “PROD_GRP” and “CUST_ID” from the source table 522. This will sum the field “value” for every unique combination of the fields “PROD_GRP” and “CUST_ID”, and write the maximum value from the transaction date field in the source records to the target table 528. Thus, the target table 528 contains one record for each unique combination of product group and customer ID and enabling the aggregation are the Sum 410 and the Group By 408 aggregation actions.

Actions such as Max, are performed on the group of records instead of the source/target field pair. In this example of the transaction records in the source table 522, the transaction records are being rolled up above the product ID level to the product group level. The first two records having product group 504 “Widgets” and customer ID 508 “CUST01”, will be rolled into one record in the target table 528. In addition, the “Value” 502 will be summed and the maximum transaction date 500 of “Mar. 7, 2008,” will be written to the record in the target table 528. The aggregation actions group the entire record set by handling all the attributes of the record set at the same time.

At runtime, the data aggregator 26 reads the aggregation parameters and constructs and executes a dynamic SQL statement. In one embodiment, the dynamic SQL statement may be in the form:

Insert Into <target_table> ( . . . ) As Select . . . . From <source_table> Group By . . .

In this particular example, the dynamic SQL statement may be:

Insert Into OD_TRANS_AGG (OrderID, LineNumber,
SubLineNumber,
EventType, CompDate, Value, GA1, GA2) As
Select PROD_GRP || ‘_’ || CUST_ID, 1,
ROWNUM, ‘SALES’, MAX(TXN_DATE),
SUM(VALUE), PROD_GRP, CUST_ID
From ACME_TXN Group By PROD_GRP, CUST_ID

Once the dynamic SQL statement is executed, the records in the source table 22 are read, the aggregation actions specified in the aggregation parameter table 532 are applied, and the resulting records written to the target table 528.

A parameter-driven approach to data aggregation has been described in which there is no code to rewrite or modified. The parameter driven data aggregation process may be set up and executed as an overall data processing package. The processing package may be multitasking such that other processes are executed at the same time as the aggregation of transaction data 20. Other types of processing may include crediting, enriching the transaction records, adding fields, and the like.

The following is a description of an implementation of the data integrator 18 and data aggregator 26 in the context of an aggregation/alignment ETL process that receives transaction data 20 in flat files and validates, enriches, aggregates, and transforms the transaction data 20 into transactions formatted for the incentive management application.

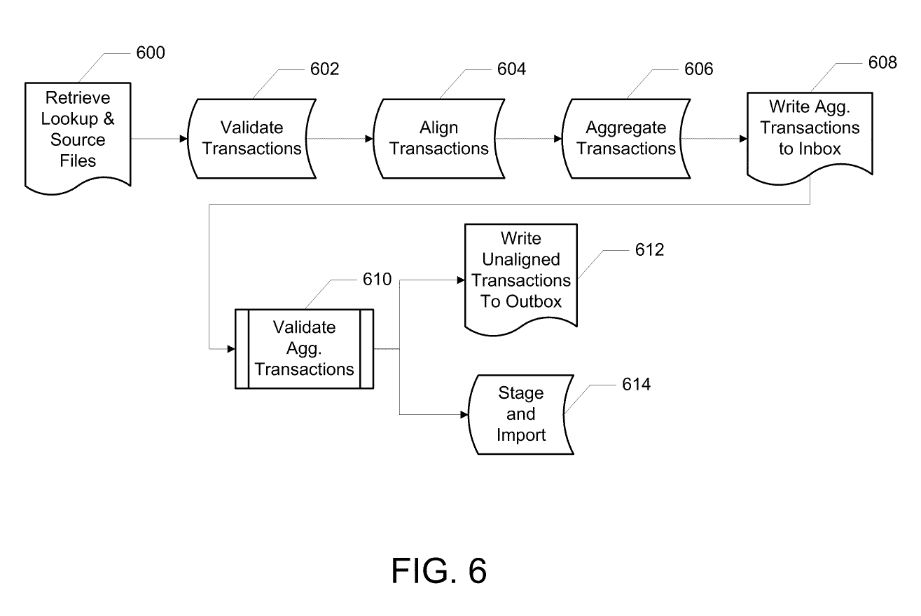

FIG. 6 is a flow diagram illustrating the aggregation/alignment process according to one embodiment. The process may include receiving lookup tables and source files containing the transaction data 20 (block 600). The lookup tables may include reference data files such as an alignment table, a product table, an excluded accounts table and a channel table, which may be used as lookups during the ETL process. The source files containing the transaction data 20 may be received from a customer inbox. Some types of source files may be held until all the files of the same type are received, and then processed as a set. The files may be processed as soon as they are received. Such inbox events may be reported using data integrator e-mail.

Whenever one of these reference data files arrives (known by its file name), reference data file may be loaded into the data integrator 18 as a simple category tree. Validation, if required, can be performed on these inbound reference data files by an integrator loader. Validation requirement specifics may be included in an inbound file inventory document. Since a source file may be processed as soon as the source file arrives, it may be necessary to load the transaction data 20 into the data integrator 18 prior to an expected transmission of transactions.

The data integrator 18 validates the transactions in the source files against one or more of the lookup tables (block 602). The data integrator 18 may also store the transactions in a pre-stage transaction table that resembles the source file in format, but without unneeded attributes. During validation, a lookup failure results if an attribute of a transaction is not found in the lookup tables. For example, validation processing may check for unknown channels, products, and/or zero-value transactions. Transaction having in lookup failures may be tagged as “unknown” and are considered “filtered”. Filtered records may be copied to a customer outbox for disposition to the customer, but in one embodiment are not omitted from further processing.

The data integrator aligns the transactions by joining the pre-stage transaction table to the alignment table (block 604). In one embodiment, alignment may determine a territory name and allocation percentage for each transaction. In one embodiment, there can be zero to many alignments for each transaction. Unaligned transactions may be copied to a rejection file in the customer outbox. Each transaction-alignment intersection and each unaligned transaction may be transformed to a format suitable for the incentive management application 14. For example, these records may be stored in an Oracle™ table that in form resembles an incentive management application transaction.

The data aggregator 26 retrieves the aggregation parameters 36 (group-by fields, aggregation types) and may perform parallel, partition aggregation on the transactions (block 606). The aggregated records may be stored in a second stage table (e.g., the target table 28) that in form resembles an incentive management application transaction. In one embodiment, the aggregation process may be reused by a quota engine of the incentive management application 14. As described above, aggregation reduces volume of the transactions. For sales transactions, the transactions may be fundamentally rolled up by, for example, product, channel, account if relevant, and zip code, but may be rolled up by other attributes which may vary according to data source and type. The aggregation process may build a dynamic SQL query with a group-by clause for each period (e.g., stored in a date field in the form “yyyymm”), to load the target table 28 from the pre-stage transaction table. Past period measures may be pivoted onto current period transactions by looking up the values in the same pre-stage transaction table.

The data integrator 18 may write current period transactions to a transaction file that is moved to a customer inbox (block 608). This inbox event may be reported using integrator e-mail. Beginning with this inbox event, the data integrator 18 may process the transaction file.

The data integrator 18 may validate the aggregated transactions to trap unaligned transactions and any other errors (block 610). Error records may be written to an error file and deposited in the customer outbox (block 612). This outbox event may be reported using integrator e-mail. Validated transaction records may be staged and imported into the incentive management application 14 for calculation of the compensation payments 24 (block 614).

A method and system for parameterizing data aggregation has been disclosed. The present invention has been described in accordance with the embodiments shown, and there could be variations to the embodiments, and any variations would be within the spirit and scope of the present invention. For example, the exemplary embodiment can be implemented using hardware, software, a computer readable medium containing program instructions, or a combination thereof. Software written according to the present invention is to be either stored in some form of computer-readable medium such as a memory, a hard disk, or a CD/DVD-ROM and is to be executed by a processor. Accordingly, many modifications may be made by one of ordinary skill in the art without departing from the spirit and scope of the appended claims.

We claim:

1. A method of parameterizing data aggregation performed by a data integrator executing on a computer, comprising:
in response to receiving business rules input from an end-user through a graphical user interface, storing the business rules as aggregation parameters in a repository external to the data integrator;
reading the aggregation parameters, the aggregation parameters specifying the source table of transaction data, a target table for storing aggregation results, and summarization requirements specifying aggregation actions to be performed on fields of at least one of the source table in the target table; and
aggregating the transaction data based on the summarization requirements, including grouping and summing transaction values, whereby the aggregation parameters enable aggregation of the transaction data from the source table to the target table without modifying code comprising the data integrator.

2. The method of claim 1 further comprising storing a plurality of records in an aggregation parameters table, at least a portion of the records specifying a source field from the source table, a target field in the target table to which the source field maps, and an aggregation action to be performed on the source field.

3. The method of claim 1 further comprising generating a SQL statement in response to reading each of the plurality of records from the parameter table that refers to the source field, the target field, and the aggregation action.

4. The method of claim 3 further comprising executing the SQL statement, wherein the aggregation action is performed on at least one of the source field and the target field to transform the source data to target data, wherein a plurality of source data records is aggregated into a lesser number of one or more target data records.

5. The method of claim 4 further comprising loading the target data in the target table into an incentive management application for compensation calculation.

6. An executable software product stored on a computer-readable medium containing program instructions for selecting and presenting a route to a user, the program instructions for:
in response to receiving business rules input from an end-user through a graphical user interface, storing the business rules as aggregation parameters in a repository external to the data integrator;
reading the aggregation parameters, the aggregation parameters specifying the source table of transaction data, a target table for storing aggregation results, and summarization requirements specifying aggregation actions to be performed on fields of at least one of the source table in the target table; and
aggregating the transaction data based on the summarization requirements, including grouping and summing transaction values, whereby the aggregation parameters enable aggregation of the transaction data from the source table to the target table without modifying code comprising the data integrator.

7. The computer-readable medium of claim 6 further comprising program instructions for storing a plurality of records in an aggregation parameters table, at least a portion of the records specifying a source field from the source table, a target field in the target table to which the source field maps, and an aggregation action to be performed on the source field.

8. The computer-readable medium of claim 6 further comprising program instructions for generating a SQL statement in response to reading each of the plurality of records from the parameter table that refers to the source field, the target field, and the aggregation action.

9. The computer-readable medium of claim 8 further comprising program instructions for executing the SQL statement, wherein the aggregation action is performed on at least one of the source field and the target field to transform the source data to target data, wherein a plurality of source data records is aggregated into a lesser number of one or more target data records.

10. The computer-readable medium of claim 9 further comprising program instructions for loading the target data in the target table into an incentive management application for compensation calculation.

11. A system, comprising:
a memory;
a processor coupled to the memory; and
a software component executed by the processor that is configured to:
in response to receiving business rules input from an end-user through a graphical user interface, store the business rules as aggregation parameters in a repository external to the data integrator;
read the aggregation parameters, the aggregation parameters specifying the source table of transaction data, a target table for storing aggregation results, and summarization requirements specifying aggregation actions to be performed on fields of at least one of the source table in the target table; and
aggregate the transaction data based on the summarization requirements, including grouping and summing transaction values, whereby the aggregation parameters enable aggregation of the transaction data from the source table to the target table without modifying code comprising the data integrator.

12. The system of claim 11 wherein a plurality of records are stored in an aggregation parameters table, at least a portion of the records specifying a source field from the source table, a target field in the target table to which the source field maps, and an aggregation action to be performed on the source field.

13. The system of claim 11 wherein a SQL statement is generated in response to reading each of the plurality of records from the parameter table that refers to the source field, the target field, and the aggregation action.

14. The system of claim 13 wherein the SQL statement is executed such that the aggregation action is performed on at least one of the source field and the target field to transform the source data to target data, wherein a plurality of source data records is aggregated into a lesser number of one or more target data records.

15. The system of claim 14 wherein the target data is loaded in the target table into an incentive management application for compensation calculation.
